(19) United States
(12) Patent Application Publication
(10) Pub. No.: US 2024/0355549 A1
(43) Pub. Date: Oct. 24, 2024

(54) MULTILAYER ELECTRONIC COMPONENT

(71) Applicant: SAMSUNG ELECTRO-MECHANICS CO., LTD., Suwon-si (KR)

(72) Inventors: Ye Rin HONG, Suwon-si (KR); Kyong Nam HWANG, Suwon-si (KR); Jong Suk JEONG, Suwon-si (KR); Yang-Seok PARK, Suwon-si (KR); Hye Mi YOO, Suwon-si (KR); Seung Min LEE, Suwon-si (KR)

(73) Assignee: SAMSUNG ELECTRO-MECHANICS CO., LTD., Suwon-si (KR)

(21) Appl. No.: 18/603,754

(22) Filed: Mar. 13, 2024

(30) Foreign Application Priority Data
Apr. 21, 2023 (KR) 10-2023-0052914

(51) Int. Cl. H01G 4/30; H01G 4/012; H01G 4/12; H01G 4/232

(52) U.S. Cl. CPC H01G 4/30; H01G 4/012; H01G 4/1227; H01G 4/2325

(57) ABSTRACT

A multilayer electronic component includes a body including a dielectric layer and internal electrodes disposed alternately with the dielectric layer in a first direction; a first side margin portion and a second side margin portion disposed on opposing side surfaces of the body; a first external electrode and a second external electrode disposed on opposing end surfaces of the body. When an average size of the first side margin portion is defined as W1, an average size of the second side margin portion is defined as W2, and an average size between external surfaces of the first and second side margin portions is defined as W0, (W1+W2)/W0<0.20 is satisfied, and when an average thickness of the dielectric layer is defined as td and an average thickness of the internal electrode is defined as te, te>td is satisfied.

### CROSS-REFERENCE TO RELATED APPLICATION(S)

This application claims the benefit of priority to Korean Patent Application No. 10-2023-0052914, filed on Apr. 21, 2023 in the Korean Intellectual Properties Office, the disclosure of which is incorporated herein by reference in its entirety.

### BACKGROUND

### 1. Field

The present disclosure relates to a multilayer electronic component.

### 2. Description of Related Art

A multilayer ceramic capacitor (MLCC), a multilayer electronic component, may be a chip-type condenser mounted on the printed circuit boards of various electronic products such as a liquid crystal display (LCD) and a plasma display panel (PDP), a computer, a smartphone, and charging or discharging electricity.

As electronic products have been designed to have a reduced size, thickness and functionality, chip components have also been required to have a reduced size, and mounting of electronic components has also become highly integrated. In response to this trend, a space between mounted electronic components has also been reduced.

In particular, in the case of a structure in which a side margin is formed on a side surface of a body to improve capacitance, it may be highly likely that moisture penetrates through the side margin portion, and when a voltage applied per unit thickness increases due to reducing a thickness of a dielectric layer and internal electrodes, it may be difficult to secure moisture resistance reliability and withstand voltage reliability.

Accordingly, in a structure in which a side margin is attached, it may be necessary to design a microstructure including internal electrodes and dielectric layers having reduced thicknesses and securing reliability of a multilayer electronic component which may have a relatively small size.

The information disclosed in the Background section above is to aid in the understanding of the background of the present disclosure, and should not be taken as acknowledgement that this information forms any part of prior art.

### SUMMARY

An example embodiment of the present disclosure is to provide a multilayer electronic component having improved capacitance properties and moisture resistance reliability.

An example embodiment of the present disclosure is to provide a multilayer electronic component having improved capacitance properties and withstand voltage reliability.

According to an example embodiment of the present disclosure, a multilayer electronic component includes a body including a dielectric layer and internal electrodes disposed alternately with the dielectric layer in a first direction, and including first and second surfaces opposing each other in the first direction, third and fourth surfaces connected to the first and second surfaces and surfaces opposing each other in a second direction, and fifth and sixth surfaces connected to the first to fourth surfaces and surfaces opposing each other in a third direction; a first side margin portion disposed on the fifth surface; a second side margin portion disposed on the sixth surface; a first external electrode disposed on the third surface; and a second external electrode disposed on the fourth surface. When an average size of the first side margin portion in the third direction is defined as W1, an average size of the second side margin portion in the third direction is defined as W2, and an average size in the third direction from an external surface of the first side margin portion to an external surface of the second side margin portion is defined as W0, (W1+W2)/W0<0.20 is satisfied, and when an average thickness of the dielectric layer is defined as td and an average thickness of the internal electrodes is defined as te, te>td is satisfied.

According to an example embodiment of the present disclosure, a multilayer electronic component includes a body including a dielectric layer and internal electrodes disposed alternately with the dielectric layer in a first direction, and including first and second surfaces opposing each other in the first direction, third and fourth surfaces connected to the first and second surfaces and surfaces opposing each other in a second direction, and fifth and sixth surfaces connected to the first to fourth surfaces and surfaces opposing each other in a third direction; a first side margin portion disposed on the fifth surface; a second side margin portion disposed on the sixth surface; a first external electrode disposed on the third surface; and a second external electrode disposed on the fourth surface. The body further includes a capacitance forming portion in which the dielectric layer and the internal electrodes are alternately disposed in the first direction to form capacitance, a first cover portion disposed on one surface of the capacitance forming portion in the first direction and a second cover portion disposed on another surface of the capacitance forming portion in the first direction. When an average size of the first cover portion in the first direction is defined as T1, an average size of the second cover portion in the first direction is defined as T2, and an average size of the body in the first direction is defined as TO, (T1+T2)/T0<0.23 is satisfied, and when an average thickness of the dielectric layer is defined as td and an average thickness of the internal electrodes is defined as te, te>td is satisfied.

### BRIEF DESCRIPTION OF DRAWINGS

The above and other aspects, features, and advantages of the present disclosure will be more clearly understood from the following detailed description, taken in combination with the accompanying drawings, in which:

FIG. 1 is a perspective diagram illustrating a multilayer electronic component according to an example embodiment of the present disclosure;

FIG. 2 is a perspective diagram illustrating a shape in which a side margin is disposed on a body according to an example embodiment of the present disclosure;

FIG. 3 is a perspective diagram illustrating a body according to an example embodiment of the present disclosure;

FIG. 4 is a cross-sectional diagram taken along line I-I′ in FIG. 1;

FIG. 5 is a cross-sectional diagram taken along line II-II′ in FIG. 1;

FIG. 6 is a diagram illustrating regions of a capacitance forming portion, a cover portion, and a side margin portion in FIG. 5.

### DETAILED DESCRIPTION

Hereinafter, embodiments of the present disclosure will be described below with reference to the accompanying drawings.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after a gaining an understanding of the disclosure of this application.

In the drawings, same elements will be indicated by the same reference numerals. Also, redundant descriptions and detailed descriptions of known functions and elements which may unnecessarily render the gist of the present disclosure obscure will not be provided. In the accompanying drawings, some elements may be exaggerated, omitted or briefly illustrated, and the sizes of the elements may not necessarily reflect the actual sizes of these elements. The terms, “include,” “comprise,” “is configured to,” or the like of the description are used to indicate the presence of features, numbers, steps, operations, elements, portions or combination thereof, and may not exclude the possibilities of combination or addition of one or more features, numbers, steps, operations, elements, portions or combination thereof.

In the drawings, a first direction may be defined as a direction in which first and second internal electrodes are alternately disposed with a dielectric layer interposed therebetween or a thickness T direction, among second and third directions perpendicular to the first direction, a second direction may be defined as a length L direction, and a third direction may be defined as a width W direction.

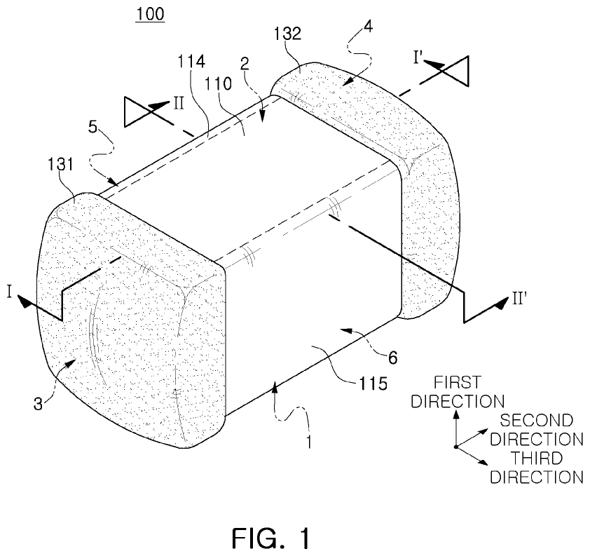

FIG. 1 is a perspective diagram illustrating a multilayer electronic component according to an example embodiment.

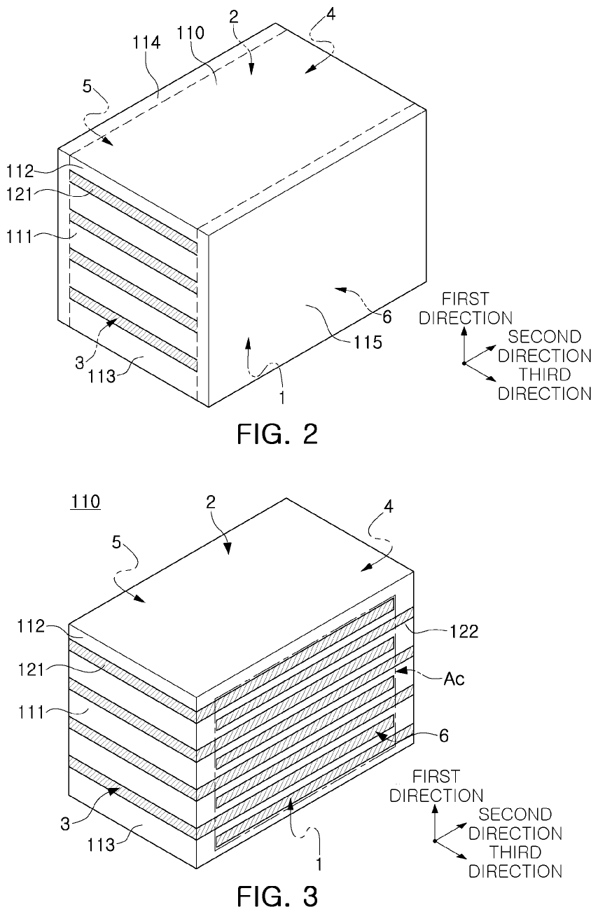

FIG. 2 is a perspective diagram illustrating a shape in which a side margin is disposed on a body according to an example embodiment.

FIG. 3 is a perspective diagram illustrating a body according to an example embodiment.

FIG. 4 is a cross-sectional diagram taken along line I-I′ in FIG. 1.

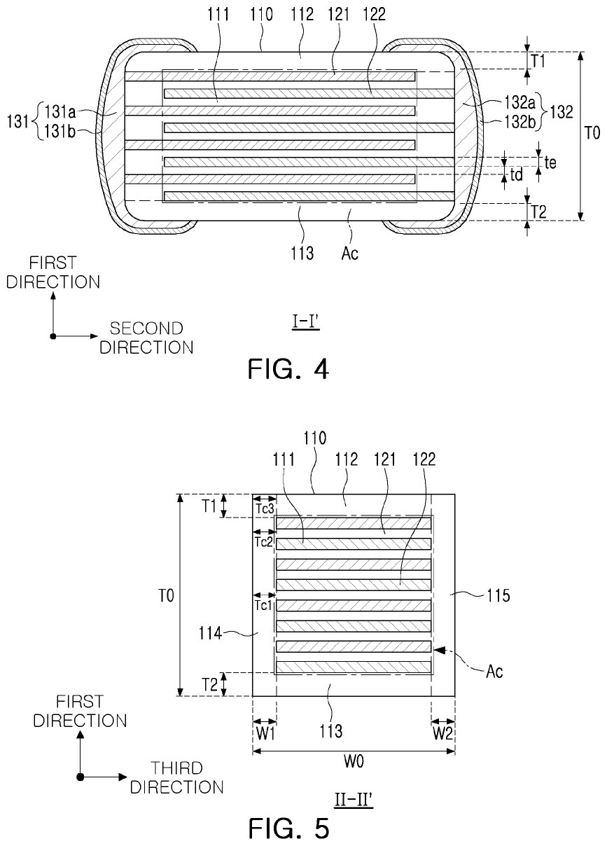

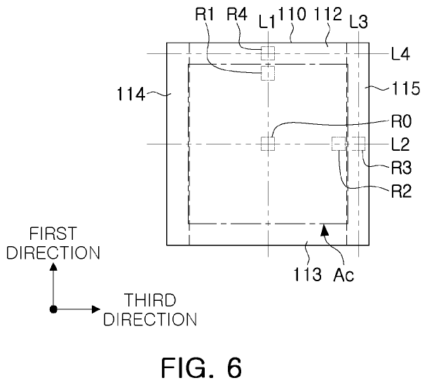

FIG. 5 is a cross-sectional diagram taken along line II-II′ in FIG. 1.

FIG. 6 is a diagram illustrating regions of a capacitance forming portion, a cover portion, and a side margin portion in FIG. 5.

Hereinafter, a multilayer electronic component 100 according to example embodiments will be described in greater detail with reference to FIGS. 1 to 6.

A multilayer electronic component 100 according to an example embodiment may include a body 110 including a dielectric layer 111 and internal electrodes 121 and 122 disposed alternately with the dielectric layer 111 in a first direction, and including first and second surfaces 1 and 2 opposing in the first direction, third and fourth surfaces 3 and 4 connected to the first and second surfaces and surfaces opposing each other in a second direction, and fifth and sixth surfaces 5 and 6 connected to the first to fourth surfaces and surfaces opposing each other in a third direction; a first side margin portion 114 disposed on the fifth surface 5; a second side margin portion 115 disposed on the sixth surface 6; a first external electrode 131 disposed on the third surface 3; and a second external electrode 132 disposed on the fourth surface 4. When an average size of the first side margin portion 114 in the third direction is defined as W1, an average size of the second side margin portion 115 in the third direction is defined as W2, and an average size in the third direction from an external surface of the first side margin portion 114 to an external surface of the second side margin portion 115 is defined as W0, (W1+W2)/W0<0.20 may be satisfied. When an average thickness of the dielectric layer 111 is defined as td and an average thickness of the internal electrodes 121 and 122 is defined as te, te>td may be satisfied.

A multilayer electronic component 100 according to an example embodiment may include a body 110 including a dielectric layer 111 and internal electrodes 121 and 122 disposed alternately with the dielectric layer 111 in a first direction, and including first and second surfaces 1 and 2 opposing in the first direction, third and fourth surfaces 3 and 4 connected to the first and second surfaces and surfaces opposing each other in a second direction, and fifth and sixth surfaces 5 and 6 connected to the first to fourth surfaces and surfaces opposing each other in a third direction; a first side margin portion 114 disposed on the fifth surface 5; a second side margin portion 115 disposed on the sixth surface 6; a first external electrode 131 disposed on the third surface 3; and a second external electrode 132 disposed on the fourth surface 4. The body 110 may further include a capacitance forming portion Ac in which the dielectric layer 111 and the internal electrodes 121 and 122 are alternately disposed in the first direction to form capacitance, a first cover portion 112 disposed on one surface of the capacitance forming portion Ac in the first direction and a second cover portion 113 disposed on the other surface of the capacitance forming portion Ac in the first direction. When an average size of the first cover portion 112 in the first direction is defined as T1, an average size of the second cover portion 113 in the first direction is defined as T2, and an average size of the body 110 in the first direction is defined as TO, (T1+T2)/T0<0.23 is satisfied, and when an average thickness of the dielectric layer is defined as td and an average thickness of the internal electrode is defined as te, te>td is satisfied.

The body 110 may include the dielectric layer 111 and the first and second internal electrodes 121 and 122 disposed alternately with the dielectric layer 111.

The shape of the body 110 may not be limited to any particular shape, but as illustrated, the body 110 may have a hexahedral shape or a shape similar to a hexahedral shape. Due to reduction of ceramic powder included in the body 110 during a firing process, the body 110 may not have an exact hexahedral shape formed by linear lines but may have a substantially hexahedral shape.

The body 110 may have first and second surfaces 1 and 2 opposing each other in the first direction, third and fourth surfaces 3 and 4 connected to the first and second surfaces 1 and 2 and opposing in the second direction, and fifth and sixth surfaces 5 and 6 connected to the first and second surfaces 1 and 2 and the third and fourth surfaces 3 and 4 and opposing each other in the third direction.

A method of forming the body 110 is not limited to any particular example. For example, the body 110 may be obtained by laminating a plurality of dielectric ceramic green sheets and conductive patterns and performing sintering. Through this sintering process, the plurality of dielectric layers 111 may have an integrated form.

As illustrated in FIG. 3, in order to maximize the capacitance per unit volume of the multilayer electronic component 100 and minimize the step between the ends of the internal electrodes 121 and 122 and the dielectric layer 111, both ends in the third direction of the internal electrodes 121 and 122 may extend to the fifth surface 5 and sixth surface 6 of the body 110, respectively.

The plurality of dielectric layers 111 forming the body 110 may be in a fired state, and a boundary between the adjacent dielectric layers 111 may be integrated with each other such that the boundary may not be distinct without using a scanning electron microscope (SEM).

In an example embodiment, a raw material for forming the dielectric layer 111 is not limited to any particular example as long as sufficient capacitance may be obtained. For example, a barium titanate-based material, a lead composite perovskite-based material, or a strontium titanate-based material may be used. The barium titanate material may include BaTiO₃ ceramic powder, and an example of the ceramic powder may include (Ba₁₋ₓCa)TiO₃ (0<x<1), Ba(Ti_{1-y}Cay)O₃ (0<y<1), (Ba₁₋ₓCaₓ)(Ti_{1-y}Zr_{y})O₃ (0<x<1, 0<y<1) or Ba(Ti_{1-y}Zr_{y})O₃ (0<y<1) in which Ca (calcium), Zr (zirconium) is partially solid-solute.

Also, various ceramic additives, organic solvents, binders, dispersants, or the like, may be added to a raw material for forming the dielectric layer 111 in the example embodiment to powder such as barium titanate (BaTiO₃).

The average thickness td of the dielectric layer 111 may not be limited to any particular example.

Generally, when the dielectric layer is formed to have a thickness of less than 0.6 μm, especially when the average thickness of the dielectric layer is less than 0.35 μm, it may be difficult to secure sufficient moisture resistance reliability. However, as in the example embodiment, when one or more of conditions 1<G1/G0, 1<G3/G0, and 1<G4/G0 (which will be explained later) are satisfied, moisture resistance reliability may be improved such that, even when the average thickness td of the dielectric layer is 0.35 μm or less, excellent moisture resistance reliability may be secured.

The average thickness td of the dielectric layer 111 may refer to the average size of the dielectric layer 111 disposed between the first and second internal electrodes 121 and 122 in the first direction. When the body 110 may include a plurality of dielectric layers 111, the average thickness td of the dielectric layer 111 may refer to the average thickness of at least one of the plurality of dielectric layers 111.

The average thickness td of the dielectric layer 111 may be measured by scanning a cross-section of the body 110 in the length and thickness directions (L-T) using a scanning electron microscope (SEM) with a magnification of 10,000. More specifically, an average value may be measured from the thicknesses of the dielectric layer 111 at 30 points spaced apart by an equal distance in the length direction in the scanned image. The 30 points at equal distances may be designated in the active portion Ac. Also, when the average value is measured by extending the measurement of the average value to ten dielectric layers 111, the average thickness of the dielectric layer 111 may be further generalized. The average thickness of the dielectric layer 111 may be measured by a standard method that will be apparent to and understood by one of ordinary skill in the art.

Referring to FIGS. 2 to 5, the body 110 may include a capacitance forming portion Ac in which the dielectric layer 111 and the internal electrodes 121 and 122 are alternately disposed in the first direction to form capacitance. The capacitance forming portion Ac may be disposed such that the dielectric layer 111 and the internal electrodes 121 and 122 may overlap each other in the first direction and may form capacitance, and may refer to a region corresponding to the internal electrodes disposed on an outermost side in the first direction among internal electrodes 121 and 122.

The capacitance forming portion Ac may contribute to capacitance formation of a capacitor, and may be formed by repeatedly laminating a plurality of first and second internal electrodes 121 and 122 with a dielectric layer 111 interposed therebetween.

A first cover portion 112 may be disposed on one surface of the capacitance forming portion Ac in the first direction, and a second cover portion 113 may be included on the other surface of the capacitance forming portion Ac in the first direction.

The first and second cover portions 112 and 113 may be formed by laminating a single dielectric layer or two or more dielectric layers on the upper and lower surfaces of the capacitance forming portion Ac in the thickness direction, respectively, and may prevent damages to the internal electrode due to physical or chemical stress.

The first cover portion 112 and the second cover portion 113 may not include internal electrodes and may include the same material as that of the dielectric layer 111.

That is, the first cover portion 112 and the second cover portion 113 may include a ceramic material, for example, a barium titanate (BaTiO₃) ceramic material.

The average thickness of the first cover portion 112 and the average thickness of the second cover portion 113 may not be limited to any particular example. However, to easily obtain miniaturization and high capacitance of the multilayer electronic component, the average thickness of the first cover portion 112 and the average thickness of second cover portion 113 may be 15 μm or less. Here, the average thickness of the first cover portion 112 may refer to the average size T1 of the first cover portion 112 in the first direction, and the average thickness of the second cover portion 113 may refer to the average size T2 of the second cover portion 113 in the first direction.

The average sizes T1 and T2 of the first and second cover portions 112 and 113 in the first direction may refer to average values obtained by measuring a distance in the first direction from the outermost surface of the first and second cover portions 112 and 113 to the internal electrodes 121 and 122 disposed on the outermost layer in the first direction using an optical microscope (OM) in the cross-section in the first and third direction polished to the central portion of the multilayer electronic component 100 second direction, or in the cross-section in the first and second direction polished to the central portion in the third direction, and performing the measurements at three or more points at equal distances in the third direction or at three or more points at equal distances in the second direction.

The internal electrodes 121 and 122 may be alternately disposed with the dielectric layer 111.

The internal electrodes 121 and 122 may include a first internal electrode 121 and a second internal electrode 122. The first and second internal electrodes 121 and 122 may be alternately disposed to oppose each other with the dielectric layer 111 included in the body 110 interposed therebetween, and may be connected to the third and fourth surfaces 3 and 4 of the body 110, respectively. Specifically, one end of the first internal electrode 121 may be connected to the third surface, and one end of the second internal electrode 122 may be connected to the fourth surface. That is, in an example embodiment, the internal electrodes 121 and 122 may be in contact with the third surface 3 or the fourth surface 4.

As illustrated in FIG. 2, the first internal electrode 121 may be spaced apart from the fourth surface 4 and may be exposed through the third surface 3, and the second internal electrode 122 may be spaced apart from the third surface 3 and may be exposed through the fourth surface 4. The first external electrode 131 may be disposed on the third surface 3 of the body 110 and may be connected to the first internal electrode 121, and the second external electrode 132 may be disposed on the fourth surface 4 of the body 110 and may be connected to the second internal electrode 122.

That is, the first internal electrode 121 may not be connected to the second external electrode 132 and may be connected to the first external electrode 131, and the second internal electrode 122 may not be connected to the first external electrode 131 and may be connected to the second external electrode 132. Accordingly, the first internal electrode 121 may be formed to be spaced apart from the fourth surface 4 by a predetermined distance, and the second internal electrode 122 may be formed to be spaced apart from the third surface 3 by a predetermined distance. In this case, the first and second internal electrodes 121 and 122 may be electrically isolated from each other by the dielectric layer 111 disposed therebetween.

Also, as described above, to increase capacitance per unit volume of the multilayer electronic component 100 and to reduce a step difference between the ends of the internal electrodes 121 and 122 and the dielectric layer 111, both ends of the internal electrodes 121 and 122 in the third direction may be in contact with the fifth surface 5 and the sixth surface 6 of the body 110, respectively.

The material for forming the internal electrodes 121 and 122 is not limited to any particular example, and a material having excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), and alloys thereof.

Also, the internal electrodes 121 and 122 may be formed by printing conductive paste for internal electrodes including one or more of nickel (Ni), copper (Cu), palladium (Pd), silver (Ag), gold (Au), platinum (Pt), tin (Sn), tungsten (W), titanium (Ti), and alloys thereof on a ceramic green sheet. A screen printing method or a gravure printing method may be used as a method of printing the conductive paste for internal electrodes, but an example embodiment thereof is not limited thereto.

The average thickness the of the internal electrodes 121 and 122 may not need to be limited to any particular example.

However, generally, when the internal electrode is formed to have a thickness of less than 0.6 μm, particularly when the thickness of the internal electrode is 0.35 μm or less, it may be difficult to secure sufficient moisture resistance reliability. However, as in an example embodiment, when one or more of conditions 1<G1/G0, 1<G3/G0, and 1<G4/G0 are satisfied, moisture resistance reliability may be improved, such that, even when the average thickness the of the internal electrode is less than 0.35 μm, excellent moisture resistance reliability may be secured.

The average thickness the of the internal electrodes 121 and 122 may refer to the average thickness the of the internal electrodes 121 and 122. When the body 110 may include a plurality of internal electrodes 121 and 122, the average thickness td of the internal electrodes 121 and 122 may refer to the average thickness of at least one of the plurality of internal electrodes 121 and 122.

The average thickness the of the internal electrodes 121 and 122 may be measured by scanning a cross-section of the body 110 in the length and thickness direction (L-T) using a scanning electron microscope (SEM) with a magnification of 10,000. More specifically, an average value may be measured from the thicknesses of the internal electrodes at 30 points spaced apart by an equal distance in the second direction in the scanned image. The 30 points at equal distances may be designated in the active portion Ac. Also, when the average value is measured by extending the measurement of the average value to ten internal electrodes, the average thickness of the internal electrodes may be further generalized. The average thickness of the internal electrodes 121 and 122 may be measured by a standard method that will be apparent to and understood by one of ordinary skill in the art.

Referring to FIGS. 1 and 3, the first side margin portion 114 may be disposed on the fifth surface of the body 110, and the second side margin portion 115 may be disposed on the sixth surface 6. Specifically, the first side margin portion 114 may be disposed to cover one surfaces of the capacitance forming portion Ac and the first and second cover portions 112 and 113 in the third direction, and the second side margin portion 115 may be disposed to cover the other surfaces of the capacitance forming portion Ac and the first and second cover portions 112 and 113 in the third direction.

The first and second side margin portions 114 and 115 may basically prevent damage to the internal electrode due to physical or chemical stress.

The method of forming the first and second side margin portions 114 and 115 is not limited to any particular example. For example, the first and second side margin portions 114 and 115 may be formed by applying a ceramic slurry for forming a side margin portion to the side surface of the laminate body 210 and performing firing, or by pressing and attaching a ceramic green sheet for forming a side margin portion and performing firing. The material forming the first and second side margin portions 114 and 115 is not limited to any particular example, and may be formed of the same material as that of the dielectric layer 111, but an example embodiment thereof is not limited thereto. When being formed of a different material from that of the dielectric layer 111, the first and second side margin portions 114 and 115 may have a different composition.

Average widths of the first and second side margin portions 114 and 115 may not need to be limited to any particular example. However, to easily obtain miniaturization and high capacitance of multilayer electronic components, an average width of the first side margin portion 114 and an average width of the second side margin portion 115 may each be 15 μm or less. When the average width of the side margin portions 114 and 115 is relatively small, such as 15 μm or less, it may be difficult to improve moisture resistance reliability of the multilayer electronic component 100. However, as in an example embodiment, when one or more of conditions 1<G1/G0, 1<G3/G0, and 1<G4/G0 are satisfied, moisture resistance reliability may be improved. Accordingly, even when the average width of the side margin portions 114 and 115 is 15 μm or less, moisture resistance reliability of the multilayer electronic component 100 may be improved.

In an example embodiment, the average width of the first side margin portion 114 may refer to the average size W1 of the first side margin portion 114 in the third direction, and the average width of the second side margin portion 115 may refer to the average size W2 of the second side margin portion 115 in the third direction.

The average sizes W1 and W2 in the third direction of the first and second side margin portions 114 and 115 may refer to average values obtained by measuring a distance in the third direction from the outermost surface of the first and second side margin portions 114 and 115 to one end of the internal electrodes 121 and 122 in the third direction using an optical microscope (OM) in the cross-sections of the multilayer electronic component 100 in the first and third directions, polished to the central portion in the second direction, and performing the measurement at three or more points at equal distances in the first direction.

The external electrodes 131 and 132 may be disposed on the third or fourth surface of the body 110. Specifically, the first external electrode 131 may be disposed on the third surface 3 and may be connected to the first internal electrode 121, and the second external electrode 132 may be disposed on the fourth surface 4 and may be connected to the second internal electrode 122.

In the example embodiment, the multilayer electronic component 100 may have two external electrodes 131 and 132, but the number of the external electrodes 131 and 132 and the shape thereof may be varied depending on the internal electrodes 121 and 122 or for other purposes.

The external electrodes 131 and 132 may be formed of any material having electrical conductivity, such as metal, and a specific material may be determined in consideration of electrical properties and structural stability, and the external electrodes 131 and 132 may have a multilayer structure.

For example, the external electrodes 131 and 132 may include electrode layers 131a and 132a disposed on the body 110 and plating layers 131b and 132b disposed on the electrode layers 131a and 132a.

For a more specific example of the electrode layers 131a and 132a, the electrode layers may be sintered electrodes including a first conductive metal and glass, or a resin-based electrode including a conductive metal and resin.

Also, the electrode layers 131a and 132a may have a form in which a plastic electrode and a resin-based electrode are formed in order on the body. Also, the electrode layers 131a and 132a may be formed by transferring a sheet including a conductive metal onto a body or by transferring a sheet including a conductive metal onto a fired electrode.

A material having excellent electrical conductivity may be used as the conductive metal included in the electrode layers 131a and 132a. For example, the conductive metal may be one or more of nickel (Ni), copper (Cu), and alloys thereof.

The plating layers may improve sealing or mounting properties. The type of the plating layers is not limited to any particular example, and a plating layer including at least one of Ni, Sn, Pd, and alloys thereof, and may include a plurality of layers.

For a more specific example of the plating layers 131b and 132b, the plating layers 131b and 132b may be plating layers including Ni or plating layers including Sn, plating layers including Ni and plating layers including Sn may be formed in order on the electrode layers 131a and 132a, and plating layers including Sn, plating layers including Ni, and plating layers including Sn may be formed in order. Also, the plating layers may include a plurality of Ni plating layers and/or a plurality of Sn plating layers

Referring to FIG. 5, in example embodiments, the average size of the first side margin portion 114 in the third direction may be defined as W1, the average size of the second side margin portion 115 in the third direction may be defined as W2, the average size in the third direction from the external surface of the first side margin portion 114 to the external surface of the second side margin portion 115 may be defined as W0, the average size of the first cover portion 112 in the first direction may be defined as T1, the average size of the second cover portion 113 in the first direction may be defined as T2, and the average size of the body 110 in the first direction may be defined as TO.

As an example of measuring W0, in the cross-sections of the multilayer electronic component 100 in the first and third directions, polished to the second direction central portion, a distance in the third direction from the outermost surface of the first side margin portion 114 to the outermost surface of the second side margin portion 115 may be measured using an optical microscope (OM), and the average value of the measurements may be measured at three or more points at equal distances in the first direction with respect to the central portion in the first direction.

As an example of measuring TO, in the cross-section in the first and third directions, formed by polishing the multilayer electronic component 100 to the central portion in the second direction, the distance between the first surface 1 and the second surface 2 of the body 110 in the first direction may be measured using an optical microscope (OM), and the average value of the measurements may be measured at three or more points at equal distances in the third direction with respect to the central portion in the third direction.

The correlation between the above-described W0, W1, W2, TO, T1, and T2 may be an important parameter affecting miniaturization, capacitance properties, and moisture resistance reliability of the multilayer electronic component 100. For example, when the value of W1+W2 is excessively larger than the value of W0, or the value of T1+T2 is excessively larger than the value of TO, the proportion of the capacitance forming portion Ac in the entire component may be reduced, such that sufficient capacitance per unit volume of the multilayer electronic component 100 may not be assured. However, when the value of W1+W2 or the value of T1+T2 is excessively reduced to increase the proportion of the capacitance forming portion Ac in the entire component, the effect in which the cover portions 112 and 113 and the side margin portions 114 and 115 protect the capacitance forming portion Ac may not be sufficiently obtained, which may adversely affect moisture resistance reliability of the multilayer electronic component 100. Accordingly, in example embodiments, the correlation between at least two of W0, W1, W2, TO, T1 and T2 may be adjusted to easily obtain miniaturization of multilayer electronic components, to secure sufficient capacitance, and to prevent deterioration of moisture resistance reliability. In the description below, various example embodiments of correlation between at least two of W0, W1, W2, TO, T1 and T2 will be described. Each condition specified in the example embodiment below may be satisfied separately or simultaneously, and when satisfied simultaneously, the effect of the example embodiment may become prominent.

In the example embodiment, (W1+W2)/W0<0.20 may be satisfied. Accordingly, the proportion of the first and second side margin portions 114 and 115 in the entire multilayer electronic component may be reduced, such that capacitance per unit volume of the multilayer electronic component may be improved.

In the example embodiment, the first side margin portion 114 may be disposed on the fifth surface 5 of the body 110, and the second side margin portion 115 may be disposed on the sixth surface 6 of the body 110. When the side margin portion is disposed separately as in the example embodiment, it may not be necessary to form the side margin portion to have a great thickness as compared to the general structure in which the margin region is formed according to the dispositional region of the internal electrode without separately disposing the side margin portion, and accordingly, capacitance per unit volume of the multilayer electronic component 100 may be improved. Accordingly, even when W1, W2 and W0 in the example embodiment satisfy (W1+W2)/W0<0.20 and the first and second side margin portions 114 and 115 have a reduced thickness, capacitance and moisture resistance reliability per unit volume of the multilayer electronic component 100 may be secured.

In the example embodiment, T1 and T2, and TO may satisfy (T1+T2)/T0<0.23. Accordingly, by minimizing the proportion of the first and second cover portions 112 and 113 in the entire multilayer electronic component, capacitance per unit volume of the multilayer electronic component may be improved.

W0 and T0 values may be related to the overall size of the multilayer electronic component 100. The W0 and TO values may be varied depending on the design purpose of the multilayer electronic component 100. In an example embodiment, W0 and T0 may satisfy 100 μm< (W0+T0)/2<250 μm, but an example embodiment thereof is not limited thereto.

In an example embodiment, W1, W2, T1, and T2 may satisfy 5 μm< (W1+W2)/2< (T1+T2)/2. The value (W1+W2)/2 may refer to the average size of the first side margin portion 114 in the third direction and the average size of the second side margin portion 115 in the third direction, and (T1+T2)/2 may refer to the average value of the average size of the first cover portion 112 in the first direction and the average size of the second cover portion 113 in the first direction.

When the (W1+W2)/2 value is excessively large, it may be difficult to improve capacitance per unit volume of the multilayer electronic component 100, and when the (W1+W2)/2 value is excessively small, capacitance per unit volume of multilayer electronic component 100 may be improved, but it may be difficult to secure moisture resistance reliability. Accordingly, in the example embodiment, W1, W2, T1, and T2 may be adjusted to satisfy 5 μm< (W1+W2)/2< (T1+T2)/2, thereby assuring both capacitance improvement properties and moisture resistance reliability per unit volume of the multilayer electronic component 100.

In the example embodiment, when the average thickness of the dielectric layer 111 is defined as td and the average thickness of the internal electrodes 121 and 122 is defined as te, te>td may be satisfied. In this case, the internal electrodes 121 and 122 may be formed to have a thickness greater than that of the dielectric layer 111, such that connectivity of the internal electrodes 121 and 122 may be improved, thereby improving HALT reliability. However, as the dielectric layer 111 is formed to have a thickness smaller than that of the internal electrodes 121 and 122, the dielectric layer 111 may become more vulnerable to penetration of external moisture and withstand voltage reliability may deteriorate. However, in example embodiments, even when te>td is satisfied, by adjusting the correlation between W0, W1, W2, TO, T1 and T2 as described above, moisture resistance reliability may be improved, and by adjusting the correlation between G0, G1, G2, G3, and G4, withstand voltage reliability may be improved. That is, when the average thickness of the dielectric layer 111 is defined as td and the average thickness of the internal electrodes 121 and 122 is defined as te, and te>td is satisfied, the effect of improving moisture resistance reliability and withstand voltage reliability according to the example embodiment may become significant, and HALT reliability may also be improved.

When the thickness deviation of the first and second side margin portions 114 and 115 by position is relatively large, the proportion of the side margin portion in a multilayer electronic component of the same size may be relatively large, such that the proportion of capacitance forming portion Ac in the entire component may not be secured, and accordingly, it may be difficult to secure high capacitance. Also, when the thickness deviation of the side margin portions 114 and 115 is large, the region of the side margin portions 114 and 115 in contact with the edge of the body 110 may be formed to have a thickness smaller than that of the first or second side margin portion 114 and 115 region in contact with the end of the internal electrode in the third direction, disposed in the central portion in the first direction among internal electrodes 121 and 122. In this case, the boundary between the side margin portions 114 and 115, which are regions vulnerable to external moisture penetration, and the body 110 may not be sufficiently covered. In particular, the issue of securing high capacitance and moisture resistance reliability may be worsen as the size of the multilayer electronic component 100, the average thickness the of the internal electrode, the average thickness td of the dielectric layer, the average thickness of the cover portions 112 and 113, or the average width of the side margin portions 114 and 115 are decreased.

Accordingly, it may be desirable for the thickness deviation of the first and second side margin portions 114 and 115 to be constant to improve moisture resistance reliability and capacitance per unit volume of the multilayer electronic component, and this effect may be more prominent when the multilayer electronic component is an ultra-small-sized high capacitance product, that is, a small-sized high capacitance multilayer electronic component having a size 0201 or less, or in which the average thickness td of the dielectric layer is 0.35 μm or less, the average thickness te of the internal electrode is 0.35 μm or less, the average thickness of the cover portion is 15 μm or less, or the average width of the side margin portion is 15 μm or less.

Specifically, in the example embodiment, a ratio tc2/tc1 of the thickness tc2 of the first or second side margin portion 114 and 115 region in contact with the end of the internal electrode in the third direction disposed on the outermost side in the first direction to a thickness tc1 of the first or second side margin portion 114 and 115 region in contact with the end of the internal electrode in the third direction disposed in the central portion in the first direction among internal electrodes 121 and 122 may be 0.9 or more and 1.0 or less. Accordingly, even when the size of the multilayer electronic component 100, the average thickness the of the internal electrode, the average thickness td of the dielectric layer, or the average thickness of the cover portions 112 and 113 are relatively small, capacitance per unit volume of the multilayer electronic component may be improved, and moisture resistance reliability may be improved.

Similarly, in an example embodiment, a ratio tc3/tc1 of a thickness tc3 of the first or second side margin portions 114 and 115 in contact with the edges of the body 110 to a thickness tc1 of the first or second side margin portion 114 and 115 region in contact with the end of the internal electrode in the third direction disposed in the central portion in the first direction among internal electrodes 121 and 122 may be 0.9 or more and 1.0 or less. Accordingly, even when the size of the multilayer electronic component 100, the average thickness the of the internal electrode, the average thickness td of the dielectric layer, or the average thickness of the cover portions 112 and 113 are relatively small, capacitance per unit volume of the multilayer electronic component may be improved, and moisture resistance reliability may be improved.

The thicknesses tc1, tc2, and tc3 in each position of the side margin portions 114 and 115 may be measured using a scanning electron microscope (SEM) in the cross-sections in the first and third directions, polished to the central portion of the multilayer electronic component in the second direction, and the thickness deviations tc2/tc1 and tc3/tc1 for each position of the side margin portions 114 and 115 may be further generalized by performing the above measurements on the first side margin portion 114 and the second side margin portion 115 and obtaining an average value thereof. The thicknesses tc1, tc2, and tc3 of the side margin portions 114 and 115 may be measured by a standard method that will be apparent to and understood by one of ordinary skill in the art.

The method of consistently controlling the thickness deviation for each position of the side margin portions 114 and 115 is not particularly limited, and for example, a method of forming the portions by attaching a ceramic green sheet to the side surface of a ceramic body may be used.

FIG. 6 illustrates the capacitance forming portion Ac, the cover portions 112 and 113 and the side margin portions 114 and 115 regions in FIG. 5 by subdividing the portions, and the internal electrode is not illustrated.

Referring to FIG. 6, in the example embodiment, the central region of the capacitance forming portion Ac may be defined as R0, the region in which the capacitance forming portion Ac is adjacent to the first and second cover portions 112 and 113 may be defined as R1, the region in which the capacitance forming portion Ac is adjacent to the first and second side margin portions 114 and 115 may be defined as R2, the central region of the first and second side margin portions 114 and 115 may be defined as R3, and the central region of the first and second cover portions 112 and 113 may be defined as R4.

As an example of configuring regions R0, R1, R2, R3 and R4, the region observed, a magnification of 50,000 times, at the point at which the third direction central line L1 and the first direction central line L2 of the first and third direction cross sections meet after polishing to the central portion of the multilayer electronic component 100 in the second direction and exposing and etching the cross-sections in the first and third directions may be defined as R1, among the internal electrodes included in the capacitance forming portion Ac, the internal electrode disposed on the outermost layer in the first direction may be observed at a magnification of 50,000 times such that the electrode may be disposed on the uppermost end of the image, and a region configured such that the central line L1 in the first direction is in the center of the image may be defined as R2, the portion was observed at a magnification of 50,000 times such that one end of the capacitance forming portion Ac in the third direction may be disposed on the side surface of the image, and the region configured such that that the central line L2 in the third direction is disposed at the center of the image may be defined as R3, the region observed, a magnification of 50,000 times, at the point at which the central line L3 of the first and second side margin portions 114 and 115 in the third direction and the central line L2 of the cross section in the first direction meet may be defined as R3, and the region observed, a magnification of 50,000 times, at the point at which the central line (LA) of the first and second cover portions 112 and 113 in the first direction and the central line L1 of the cross-section in the third direction meet may be defined as R4. The image used when configuring the region of R1 to R4 may be observed with a scanning electron microscope (SEM), but an example embodiment thereof is not limited thereto.

As described above, each of the first and second cover portions 112 and 113 and the first and second side margin portions 114 and 115 may also include a dielectric layer, similarly to the capacitance forming portion Ac. The dielectric layer included in the first and second cover portions 112 and 113, the dielectric layer included in the first and second side margin portions 114 and 115, and the dielectric layer included in the capacitance forming portion Ac may have different compositions, but an example embodiment it is not limited thereto.

In an example embodiment, the average grain size of the dielectric layer in the central region R0 of the capacitance forming portion Ac may be defined as G0, the average grain size of the dielectric layer in region R1 in which the capacitance forming portion Ac is adjacent to the first and second cover portions 112 and 113 may be defined as G1, the average grain size of the dielectric layer in the region R2 in which the capacitance forming portion Ac is adjacent to the first and second side margin portions 114 and 115 may be defined as G2, the average grain size of the dielectric layer of the central region R3 of the first and second side margin portions 114 and 115 may be defined as G3, and the average grain size of the dielectric layer of the central region R4 of the first and second cover portions 112 and 113 may be defined as G4.

As an example of measuring the values of G0, G1, G2, G3, and G4, a method of measuring the length of the minor axis and major axis of 10 or more grains in each region and averaging the lengths, or a method of measuring the area of grains in pixels and converting the area to an equivalent circle diameter may be used, but an example embodiment thereof is not limited thereto. The average grain size of the dielectric layer may be measured by a standard method that will be apparent to and understood by one of ordinary skill in the art.

Hereinafter, the example in which, by subdividing the capacitance forming portion Ac, the first and second cover portions 112 and 113, and the first and second side margin portions 114 and 115, and adjusting the average grain size of the dielectric layer in each region, the capacitance per unit volume of multilayer electronic component may sufficiently improve and withstand voltage properties may improve will be described. Each condition specified in the example embodiment below may be satisfied separately or simultaneously, and when satisfied simultaneously, the effect of the example embodiment may become more prominent.

In an example embodiment, G1 and G0 may satisfy 1<G1/G0<1.3.

Specifically, when the G1/G0 value is 1 or less, it may be advantageous in terms of securing capacitance, but accordingly, density may be reduced due to insufficient grain growth of the dielectric in region R1 adjacent to the first and second cover portions 112 and 113, such that moisture resistance reliability of the multilayer electronic component may be reduced. Also, insulation breakdown may easily occur in a high temperature environment, and DC-bias properties may also deteriorate.

When the G1/G0 value is 1.3 or more, moisture resistance reliability may be improved, but high-temperature IR deterioration may occur due to insufficient grain growth of the dielectric in the central region R0 of the capacitance forming portion Ac. Since the average dielectric particle size in the central region R0 of Ac is not sufficient, it may not be easy to implement sufficient capacitance per unit volume.

Accordingly, as in the example embodiment, when G1 and G0 satisfy 1<G1/G0<1.3, moisture resistance reliability, high temperature reliability, capacitance per unit volume, and DC-bias properties of the multilayer electronic component 100 may be improved.

In an example embodiment, G2 and G0 may satisfy 0.9<G2/G0<1.3. Accordingly, withstand voltage reliability and capacitance per unit volume of the multilayer electronic component may be improved by allowing a fine-grained dielectric layer having improved withstand voltage reliability and a coarse-grained dielectric layer having high dielectric constant to be present simultaneously in the capacitance forming portion. However, when the G2/G0 value is 1.3 or higher or 0.9 or lower and the difference in average grain size for each region excessively increases, capacitance properties may deteriorate. Accordingly, as in the example embodiment, as G2 and G0 satisfy 0.9<G2/G0<1.3, withstand voltage reliability and capacitance per unit volume of the multilayer electronic component may improve. However, it is desirable to exclude the example in which G2=G0. In other words, G2 and G0 may satisfy 0.9<G2/G0<1 and 1<G2/G0<1.3.

In an example embodiment, G3 and G0 may satisfy 1<G3/G0<1.3.

Specifically, when the G3/G0 value is 1 or less, it may be advantageous in terms of securing capacitance, but density decreases due to insufficient dielectric grain growth in the central region R3 of the first and second side margin portions 114 and 115, such that moisture resistance reliability of the multilayer electronic component may be reduced. Also, insulation breakdown may easily occur in a high temperature environment, and DC-bias properties may also deteriorate.

When the G3/G0 value is 1.3 or more, moisture resistance reliability may be improved, but high-temperature IR deterioration may occur due to insufficient grain growth of the dielectric in the central region R0 of the capacitance forming portion Ac. Also, since the average dielectric particle size in the central region R0 of Ac is not sufficient, it may not be easy to implement sufficient capacitance per unit volume.

Accordingly, as in the example embodiment, when G3 and G0 satisfy 1<G3/G0<1.3, moisture resistance reliability, high temperature reliability, capacitance per unit volume, and DC-bias properties of the multilayer electronic component 100 may be improved.

In an example embodiment, G4 and G0 may satisfy 1<G4/G0<1.4.

Specifically, when the G4/G0 value is 1 or less, it may be advantageous in terms of securing capacitance, but accordingly, density may be reduced due to insufficient grain growth of the dielectric in the central region R4 of the first and second cover portions 112 and 113, such that moisture resistance reliability of the multilayer electronic component may be reduced. Also, insulation breakdown may easily occur in a high temperature environment, and DC-bias properties may also deteriorate.

When the G4/G0 value is 1.4 or more, moisture resistance reliability may be improved, but high-temperature IR deterioration may occur due to insufficient grain growth of the dielectric in the central region R0 of the capacitance forming portion Ac. Also, since the average dielectric particle size in the central region R0 of Ac is not sufficient, it may not be easy to implement sufficient capacitance per unit volume.

Accordingly, as in the example embodiment, when G4 and G0 satisfy 1<G4/G0<1.4, moisture resistance reliability, high temperature reliability, capacitance per unit volume, and DC-bias properties of the multilayer electronic component 100 may be improved, the central region R0 of the capacitance forming portion Ac may include a relatively fine-grained dielectric layer having improved withstand voltage reliability, and the central region R3 of the first and second cover portions 112 and 113 may include a coarse-grained dielectric layer regardless of the improvement of internal pressure reliability such that moisture resistance reliability may improve.

It may not be necessary to specifically limit the size of the multilayer electronic component 100.

However, in order to obtain miniaturization and high capacitance at the same time, to increase the number of laminations by reducing the thickness of the dielectric layer and internal electrode, it may be difficult to secure moisture resistance reliability in the multilayer electronic component 100 having a size of 0201 (length×width, 0.2 mm×0.1 mm) or less. However, as in the example embodiment, when one or more of conditions 1<G1/G0, 1<G3/G0, and 1<G4/G0 are satisfied, moisture resistance reliability may be improved, such that moisture resistance reliability of the ultra-small multilayer electronic component 100 having a size of 0201 (length×width, 0.2 mm×0.1 mm) or less may be secured.

Accordingly, considering manufacturing errors and the size of external electrode, when the length of the multilayer electronic component 100 is 0.22 mm or less and the width is 0.11 mm or less, the effect of improving reliability according to the example embodiment may be more significant. Here, the length of the multilayer electronic component 100 may refer to the maximum size of the multilayer electronic component 100 in the second direction, and the width of the multilayer electronic component 100 may refer to the maximum size of the multilayer electronic component 100 in the third direction.

According to the aforementioned embodiments, by adjusting the correlation between values related to at least one of the body, the capacitance forming portion, the side margin portion and the cover portion of the multilayer electronic component, capacitance properties and moisture resistance reliability may be improved.

Also, by adjusting the correlation of at least two of the grain size of the dielectric layer for each region of the capacitance forming portion, the grain size of the cover portion dielectric layer, and the grain size of the side margin portion dielectric layer, capacitance properties and withstand voltage reliability of the multilayer electronic components may be improved.

While the example embodiments have been illustrated and described above, it will be configured as apparent to those skilled in the art that modifications and variations could be made without departing from the scope of the present disclosure as defined by the appended claims.

What is claimed is:

1. A multilayer electronic component, comprising:
a body including a dielectric layer and internal electrodes disposed alternately with the dielectric layer in a first direction, and including first and second surfaces opposing each other in the first direction, third and fourth surfaces connected to the first and second surfaces and surfaces opposing each other in a second direction, and fifth and sixth surfaces connected to the first to fourth surfaces and surfaces opposing each other in a third direction;
a first side margin portion disposed on the fifth surface;
a second side margin portion disposed on the sixth surface;
a first external electrode disposed on the third surface; and
a second external electrode disposed on the fourth surface,
wherein, when an average size of the first side margin portion in the third direction is defined as W1, an average size of the second side margin portion in the third direction is defined as W2, and an average size in the third direction from an external surface of the first side margin portion to an external surface of the second side margin portion is defined as W0, (W1+W2)/W0<0.20 is satisfied, and
wherein, when an average thickness of the dielectric layer is defined as td and an average thickness of the internal electrodes is defined as te, te>td is satisfied.

2. The multilayer electronic component of claim 1,
wherein the body further includes a capacitance forming portion in which the dielectric layer and the internal electrodes are alternately disposed in the first direction to form capacitance, a first cover portion disposed on one surface of the capacitance forming portion in the first direction, and a second cover portion disposed on another surface of the capacitance forming portion in the first direction, and
wherein, when an average size of the first cover portion in the first direction is defined as T1, an average size of the second cover portion in the first direction is defined as T2, and an average size of the body in the first direction is defined as T0, (T1+T2)/T0<0.23 is satisfied.

3. The multilayer electronic component of claim 1, wherein, when an average size of the body in the first direction is defined as T0, 100 μm< (W0+T0)/2<250 μm is satisfied.

4. The multilayer electronic component of claim 1,
wherein the body further includes a capacitance forming portion in which the dielectric layer and the internal electrodes are alternately disposed in the first direction to form capacitance, a first cover portion disposed on one surface of the capacitance forming portion in the first direction, and a second cover portion disposed on another surface of the capacitance forming portion in the first direction, and
wherein, when an average size of the first cover portion in the first direction is defined as T1 and an average size of the second cover portion in the first direction is defined as T2, 5 μm< (W1+W2)/2< (T1+T2)/2 is satisfied.

5. The multilayer electronic component of claim 1,
wherein the body further includes a capacitance forming portion in which the dielectric layer and the internal electrodes are alternately disposed in the first direction to form capacitance, a first cover portion disposed on one surface of the capacitance forming portion in the first direction, and a second cover portion disposed on another surface of the capacitance forming portion in the first direction, and
wherein, when an average grain size of the dielectric layer in a central region of the capacitance forming portion is defined as G0, and an average grain size of the dielectric layer in a region in which the capacitance forming portion is adjacent to the first and second cover portions is defined as G1, 1<G1/G0<1.3 is satisfied.

6. The multilayer electronic component of claim 1,
wherein the body further includes a capacitance forming portion in which the dielectric layer and the internal electrodes are alternately disposed in the first direction to form capacitance, and
wherein, when an average grain size of the dielectric layer in a central region of the capacitance forming portion is defined as G0, and an average grain size of the dielectric layer in a region in which the capacitance forming portion is adjacent to the first and second side margin portions is defined as G2, 0.9<G2/G0<1.3 is satisfied.

7. The multilayer electronic component of claim 1,
wherein the body further includes a capacitance forming portion in which the dielectric layer and the internal electrodes are alternately disposed in the first direction to form capacitance, and
wherein, when an average grain size of the dielectric layer in a central region of the capacitance forming portion is defined as G0 and an average grain size of the dielectric layer in a central region of the first and second side margin portions is defined as G3, 1<G3/G0<1.3 is satisfied.

8. The multilayer electronic component of claim 1,
wherein the body further includes a capacitance forming portion in which the dielectric layer and the internal electrodes are alternately disposed in the first direction to form capacitance, and
wherein, when an average grain size of the dielectric layer in a central region of the capacitance forming portion is defined as G0, and an average grain size of the dielectric layer in a central region of the first and second cover portions is defined as G4, 1<G4/G0<1.4 is satisfied.

9. The multilayer electronic component of claim 1, wherein, when a thickness of the first or second side margin portion in contact with an end of an internal electrode in the third direction, disposed in an outermost portion in the first direction among the internal electrodes, is defined as tc2 and a thickness of the first or second side margin portion in contact with an end of an internal electrode in the third direction, disposed in a central portion in the first direction among the internal electrodes, is defined as tc1, a ratio tc2/tc1 is 0.9 or more and 1.0 or less.

10. The multilayer electronic component of claim 1, wherein, when a thickness of the first or second side margin portion in contact with an edge of the body is defined as tc3 and a thickness of the first or second side margin portion in contact with an end of an internal electrode in the third direction, disposed in a central portion in the first direction among the internal electrodes, is defined as tc1, a ratio tc3/tc1 is 0.9 or more and 1.0 or less.

11. A multilayer electronic component, comprising:
a body including a dielectric layer and internal electrodes disposed alternately with the dielectric layer in a first direction, and including first and second surfaces opposing each other in the first direction, third and fourth surfaces connected to the first and second surfaces and surfaces opposing each other in a second direction, and fifth and sixth surfaces connected to the first to fourth surfaces and surfaces opposing each other in a third direction;
a first side margin portion disposed on the fifth surface;
a second side margin portion disposed on the sixth surface;
a first external electrode disposed on the third surface; and
a second external electrode disposed on the fourth surface,
wherein the body further includes a capacitance forming portion in which the dielectric layer and the internal electrodes are alternately disposed in the first direction to form capacitance, a first cover portion disposed on one surface of the capacitance forming portion in the first direction and a second cover portion disposed on another surface of the capacitance forming portion in the first direction,
wherein, when an average size of the first cover portion in the first direction is defined as T1, an average size of the second cover portion in the first direction is defined as T2, and an average size of the body in the first direction is defined as T0, (T1+T2)/T0<0.23 is satisfied, and
wherein, when an average thickness of the dielectric layer is defined as td and an average thickness of the internal electrodes is defined as te, te>td is satisfied.

12. The multilayer electronic component of claim 11, wherein, when an average size in the third direction from an external surface of the first side margin portion to an external surface of the second side margin portion is defined as W0 and an average size of the body in the first direction is defined as T0, 100 μm<(W0+T0)/2<250 μm is satisfied.

13. The multilayer electronic component of claim 11, wherein, when an average size of the first side margin portion in the third direction is defined as W1 and an average size of the second side margin portion in the third direction is defined as W2, 5 μm<(W1+W2)/2< (T1+T2)/2 is satisfied.

14. The multilayer electronic component of claim 11, wherein, when an average grain size of the dielectric layer in a central region of the capacitance forming portion is defined as G0, and an average grain size of the dielectric layer in a region in which the capacitance forming portion is adjacent to the first and second cover portions is defined as G1, 1<G1/G0<1.3 is satisfied.

15. The multilayer electronic component of claim 11, wherein, when an average grain size of the dielectric layer in a central region of the capacitance forming portion is defined as G0, and an average grain size of the dielectric layer in a region in which the capacitance forming portion is adjacent to the first and second side margin portions is defined as G2, 0.9<G2/G0<1.3 is satisfied.

16. The multilayer electronic component of claim 11, wherein, when an average grain size of the dielectric layer in a central region of the capacitance forming portion is defined as G0, and an average grain size of the dielectric layer in a central region of the first and second side margin portions is defined as G3, 1<G3/G0<1.3 is satisfied.

17. The multilayer electronic component of claim 11, wherein, when an average grain size of the dielectric layer in a central region of the capacitance forming portion is defined as G0, and an average grain size of the dielectric layer in a central region of the first and second cover portions is defined as G4, 1<G4/G0<1.4 is satisfied.

18. The multilayer electronic component of claim 11, wherein, when a thickness of the first or second side margin portion in contact with an end of an internal electrode in the third direction, disposed in an outermost portion in the first direction among the internal electrodes, is defined as tc2 and a thickness of the first or second side margin portion in contact with an end of an internal electrode in the third direction, disposed in a central portion in the first direction among the internal electrodes, is defined as tc1, a ratio tc2/tc1 is 0.9 or more and 1.0 or less.

19. The multilayer electronic component of claim 11, wherein, when a thickness of the first or second side margin portion in contact with an edge of the body is defined as tc3 and a thickness of the first or second side margin portion in contact with an end of an internal electrode in the third direction, disposed in a central portion in the first direction among the internal electrodes, is defined as tc1, a ratio tc3/tc1 is 0.9 or more and 1.0 or less.
